(19) United States
(12) Patent Application Publication
(10) Pub. No.: US 2025/0378353 A1
(43) Pub. Date: Dec. 11, 2025

(54) GENERATIVE ARTIFICIAL-INTELLIGENCE-BASED INTEGRATION SCENARIO GENERATION

(71) Applicant: SAP SE, Walldorf (DE)

(72) Inventors: Deepak Govardhanrao Deshpande, Bengaluru (IN); Sripad J, Bangalore (IN); Prasanth Ganesh Rao, Bangalore (IN); Sana Faraz, Bangalore (IN); Ajay Kumar Pandey, Bangalore (IN)

(21) Appl. No.: 18/735,911

(22) Filed: Jun. 6, 2024

(51) Int. Cl. G06N 5/022

(52) U.S. Cl. CPC G06N 5/022

(57) ABSTRACT

The disclosure generally describes methods, software, and systems for generation of a configurable and executable integration scenario. A request to generate a data sequence integration scenario is received. The request includes one or more textual requirements. The request is validated by processing the one or more textual requirements to determine inclusion of a minimal number of systems and actions. An intent and a context of the request are determined, using a first prediction engine, from the one or more textual requirements. The intent includes top-ranked systems and APIs matching the request. The intent and the context of the request are inputted as a prompt to a second prediction engine. The data sequence integration scenario is received, from the second prediction engine, responsive to the prompt. The data sequence integration scenario defines an order of the actions to be performed by the top-ranked systems and APIs matching the request.

### TECHNICAL FIELD

The present disclosure relates to generation of a configurable and executable integration scenario. More particularly, implementations of the present disclosure are directed to generation of a data sequence integration scenario using generative artificial intelligence (Gen AI) as a tool.

### BACKGROUND

Generating executable integration scenarios can be a tedious task that involves different systems and/or applications. The involved systems can have varying architectures, technologies, and data formats making the scenarios prone to errors. In some cases, generation of executable integration scenarios includes repetitive tasks and activities. The repetitions can include addition of scenario steps in the integration of data sequence, addition of connectors to external systems, and addition of adapters for the external systems, which are part of the integration. In many cases, repetitions can be identified for the generation of executable integration scenarios, but it might not be clear as to which of the scenario steps, connectors, or adapters would be most efficient.

### SUMMARY

Implementations of the present disclosure are directed to techniques and tools for generation of a configurable and executable integration scenario. More particularly, implementations of the present disclosure are directed to generation of data sequence integration using generative artificial intelligence (Gen AI) as a tool.

In some implementations, a method includes: receiving a request to generate a data sequence integration scenario, the request including one or more textual requirements; validating the request by processing the one or more textual requirements to determine inclusion of a minimal number of systems and actions; determining, using a first prediction engine, an intent and a context of the request from the one or more textual requirements, the intent including top-ranked systems and APIs matching the request; inputting the intent and the context of the request as a prompt to a second prediction engine; and receiving, from the second prediction engine, the data sequence integration scenario, responsive to the prompt, the data sequence integration scenario defining an order of the actions to be performed by the top-ranked systems and APIs matching the request.

The foregoing and other implementations can each optionally include one or more of the following features, alone or in combination. In particular, implementations can include all of the following features:

In a first aspect, combinable with any of the previous aspects, wherein the first prediction engine and the second prediction engine include a trained large language model. In another aspect, combinable with any of the previous aspects, the trained large language model is trained using a plurality of requests mapped to system and API sequence settings. In another aspect, combinable with any of the previous aspects, the system and API sequence settings define workflow conditions for a plurality of system types and API types. In another aspect, combinable with any of the previous aspects, the computer-implemented method further includes: determining, using the first prediction engine, the plurality of system types and API types; ranking the plurality of system types and API types as a ranked system and API list; receiving a selection of system types and API types from the ranked system and API list; and generating an enriched intent including the selection of system types and API types. In another aspect, combinable with any of the previous aspects, the computer-implemented method further includes: invoking a migration by retrieving one or more systems and APIs in a sequence of systems and APIs from a database, the migration calling predefined templates. In another aspect, combinable with any of the previous aspects, the computer-implemented method further includes generating a graphical representation of the sequence of systems and APIs as the data sequence integration scenario. In another aspect, combinable with any of the previous aspects, validating the request by processing the one or more textual requirements includes a verification of use cases and supported features of an enterprise system. In another aspect, combinable with any of the previous aspects, determining, using the first prediction engine, the intent of the request includes accessing external libraries and providing an authorization token to the first prediction engine to access system data and API data to discover available systems and available APIs matching the request.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient automatic generation and optimization of executable integration scenario including data sequence integration. The system streamlines the action, system, and API discovery process by validating requests and limiting search of systems to matching contexts and intent, enabling efficient exploration and evaluation of the available options without an overwhelming complexity. The described implementation provides an enhanced system productivity. By automating a sequence of request validation and generation of enriched intents, the system enhances productivity, saving valuable time and effort in generation and execution of integration scenario workflows with ranked systems and APIs, which minimizes usage of system resources and eliminates system incompatibility. The described enhanced implementations facilitate using a user-friendly interface for generation of data sequence integration, and a seamless process for invoking the data sequence.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of data sequence integration, according to some implementations of the present disclosure.

FIG. 2 is a block diagram of an example system architecture for generation of data sequence integration, according to some implementations of the present disclosure.

FIG. 3 is a block diagram of an example data sequence integration generation scenario, according to some implementations of the present disclosure.

FIG. 4 is a flowchart of an example process for generation of data sequence integration, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to generation of a configurable and executable integration scenario including a data sequence integration scenario. More particularly, implementations of the present disclosure are directed to generation of data sequence integration scenario using generative artificial intelligence (Gen AI) as a tool. The Gen AI is configured to identify and integrate repeated tasks for creating a configurable and executable integration scenario based on a description of the scenario provided in natural language. The generated executable integration scenario is presented to users within a graphical user interface (GUI) with digital assistants. In this manner, user-friendly and intuitive explanations of scenario steps in the integration sequence, connectors to external systems, and adapters for the external systems, can be provided in hand with graphical representations of the executable integration scenario.

Traditional protocols of executable integration scenario generation include errors related to incorrect or unoptimized selection of scenario steps in the integration sequence, unsuitable connectors to external systems, or incompatible adapters for the external systems. Addressing the limitations of traditional protocols of executable integration scenario generation, the Gen-AI-based protocol described in the present disclosure enables automatic generation and optimization of executable integration scenario including data sequence integration scenario. According to the described approach, a request to generate a data sequence integration scenario is validated before determining an intent of the request. For example, the request validation is enhanced to seamlessly identify and integrate compatible internal and external systems. The described approach also provides the intent and a context of the request as a prompt to a prediction engine that is trained in generating optimized executable integration scenarios. The described solution overcomes potential challenges in optimizing executable integration scenarios for practical, task-oriented data scenarios while ensuring efficient and contextually relevant system invocations using suitable connectors to external systems and compatible adapters for the external systems. The approach broadens the scope of prediction engines (e.g., Gen AI) by advantageously addressing considerations regarding optimization, accuracy, and adaptability in handling diverse system configurations. As another advantage, the described approach addresses the balance between natural language text validation and purposeful task execution using prediction engines (e.g., Gen AI) for identification and optimization of configurable and executable integration scenarios including data sequence integration.

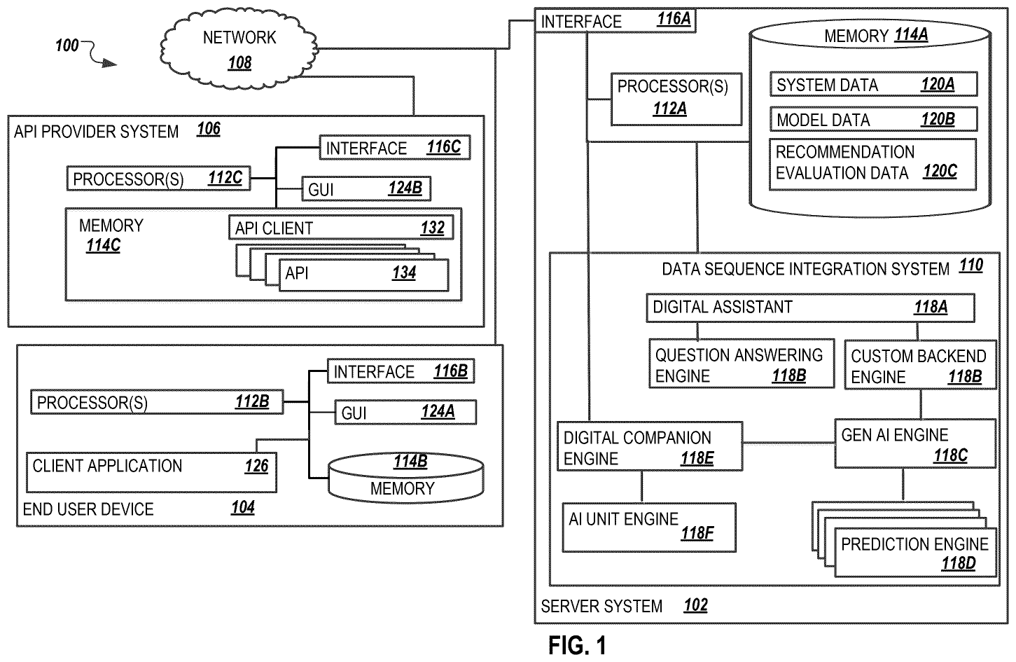

FIG. 1 is a block diagram of an example system 100 for generation of data sequence integration scenario, according to some implementations of the present disclosure. Specifically, the illustrated example system 100 includes or is communicably coupled with a server system 102, an end-user device 104, an application programming interface (API) provider system 106, and a network 108. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services and provides such services to any number of end-user devices 104 (e.g., the user device 104 over the network 108). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes. For example, the server system 102 includes a data sequence integration system 110, a processor 112A, a memory 114A, and an interface 116A.

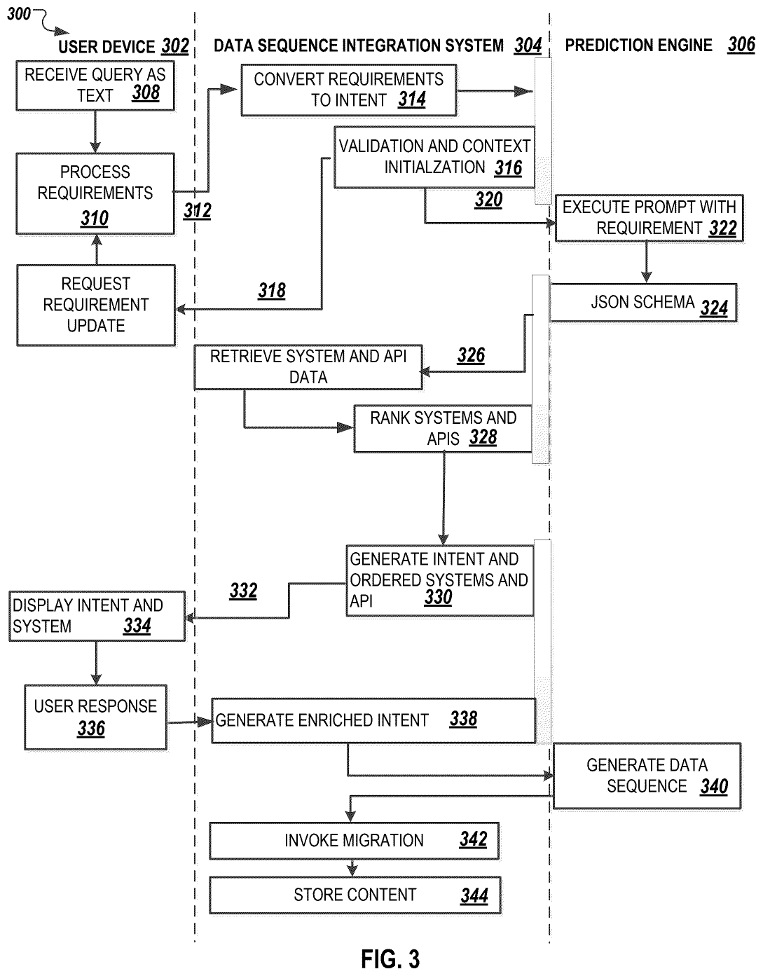

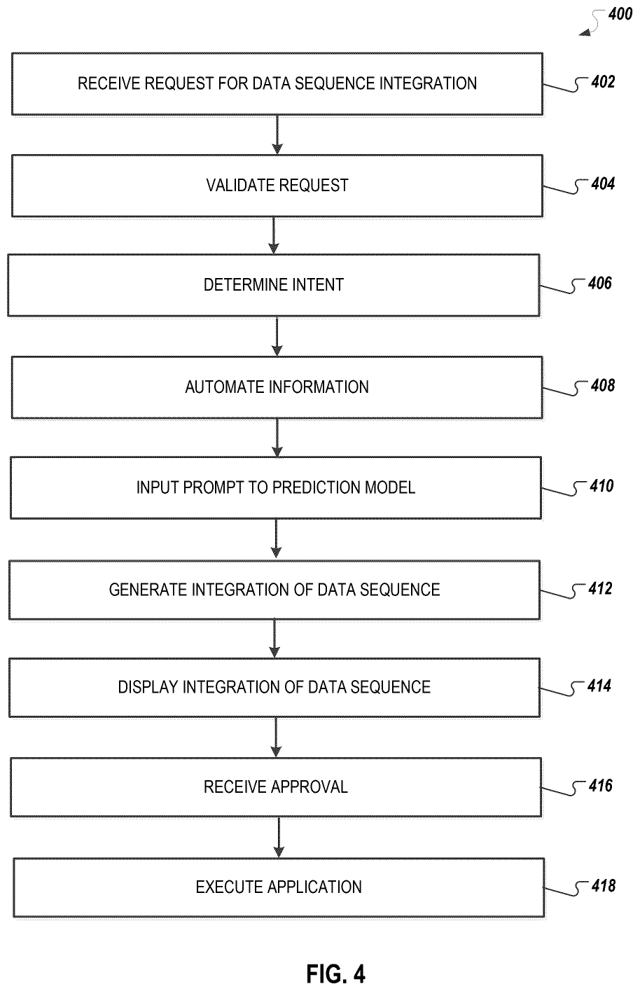

The data sequence integration system 110 can include a digital assistant system 118A (e.g., Gen-AI-based digital assistant), a question answering engine 118B, a Gen AI engine 118C, a prediction engine 118D, a digital companion engine 118E, and an AI unit engine 118F. The data sequence integration system 110 is coupled to the processor 112A, the memory 114A, and the interface 116A for generation of data sequence integration scenario. For example, as end user devices 104 generate requests for data sequence integration scenarios, the data sequence integration system 110 can be used to generate the data sequence integration scenario as described with reference to FIGS. 3 and 4. The components of the data sequence integration system 110, including the digital assistant system 118A, the question answering engine 118B, the Gen AI engine 118C, the prediction engine 118D, the digital companion engine 118E, and/or the AI unit engine 118F provide machine learning (Gen AI) functionality for optimizing generation of data sequence integration scenario. For example, the digital assistant system 118A of the present disclosure is coupled to the interface 116A to provide an integrated UI rendering solution within a digital assistant that leverages Gen AI to infer the user intent from the chat and identify the system to be called having the capability to execute generation of the data sequence integration scenario. More particularly, the digital assistant system 118A of the present disclosure calls the Gen AI engine 118C to leverage the ability of the prediction engine 118D including large language models (LLMs) to generate code and an understanding of the system data 120A to automatically create a UI solution based on a user question and context. The digital companion engine 118E can leverage the data from the AI unit engine 118F to aggregate alerts, metrics, and insights about product portfolio with a single access point for optimizing data integration for generation of configurable and executable integration scenarios.

The memory 114A can include system data 120A, model data 120B, and system recommendation data 120C. The system data (e.g., metadata) 120A can include a description of system input, system output, dependencies, connectors, compatible adapters and mapping. The system data 120A can include documents defining aspects that point to external systems (e.g., APIs of API provider system(s) 110). The system data 120A can provide references to external resources, which can be described by the integration target via open resource discovery (ORD). In some implementations, a dependency defined by mapping can also point to resources within a same system (e.g., if the resource is to be used by the integration target as an information backchannel and/or if it defines the contract for the integration target. The data sequence integration system 110 can build and train prediction engine(s) 118D based on the model data 120B, to generate trained prediction engine(s) 118D. The memory 114A can also store system recommendation data 120C generated by the data sequence integration system 110 for data sequence integration.

The end-user device 104 and the API provider system 106 may each be any computing device operable to connect to or communicate in the network(s) 108 using a wireline or wireless connection. In general, each of the end-user device 104 and the API provider system 106 includes an electronic computer device operable to receive, transmit, process, and store any appropriate data associated with the system 100 of FIG. 1. Each of the end-user device 104 and the API provider system 106 is generally intended to encompass any client computing device such as a laptop/notebook computer, wireless data port, smart phone, personal data assistant (PDA), tablet computing device, one or more processors within these devices, or any other suitable processing device. The user device 104 and the API provider system 106 respectively include interface(s) 116B and 116C, processor(s) 112B and 112C, memories 114B and 114C, and graphical user interface(s) (GUIs) 124A and 124B. The end-user device 104 can include one or more applications 126. The application 126 can be any type of application that allows a user device to request and view content on the user device (e.g., generate a request for data sequence integration scenario). In some implementations, an application 126 can use parameters, metadata, and other API and event dependency information received at launch to access the data sequence integration system 110 from the server system 102. In some instances, an application 126 can be an agent or client-side version of the one or more enterprise applications running on an enterprise server (not shown).

In accordance with implementations of the present disclosure, the application 126 includes a digital assistant that enables interactions with the user device 104. For example, and as described in further detail herein, the digital assistant of the user device 104 can receive a query. In some examples, one or more query responses can include data that is presented as a graphical representation in the GUI 124A. In accordance with implementations of the present disclosure, the digital assistant can present data as a graphical representation in a popover container within a window therein. In some examples, the popover container is provided as an iframe-based container and the digital assistant communicates with the popover container using remote procedure calls.

As described in further detail herein, a user can input a query to the digital assistant and the digital assistant can receive a response to the query. In accordance with implementations of the present disclosure, the response can include a set of systems and APIs for data sequence integration scenario. In some examples, the response can include a graphical representation of the data sequence integration scenario that is generated by the prediction engine 118D (e.g., LLM) in view of the context of the request and is displayed in a UI of the digital assistant. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any or all of the components of the example system 100, both hardware or software (or a combination of hardware and software), may interface with each other or the interface(s) 116A, 116B, and 116C (or a combination of both) over the network 108 for data sequence integration scenario. The functionality of the end-user device 104 can be accessible for all service consumers using the application 126 that transmits prompts to the data sequence integration system 110 to generate data sequence integration scenario using relevant external systems including APIs 134. The APIs 134 may include specifications for routines, data structures, and object classes. The APIs 134 can be either computer-language independent or dependent and refer to a complete interface, a single function, or even a set of APIs 134 that are called, by the data sequence integration system 110, for providing software services to the end-user device 104 or other components (whether or not illustrated) that are communicably coupled to the end-user device 104.

For example, the end-user device 104 and/or the API provider system 106 may include a computer that includes an input device, such as a keypad, touch screen, or other device that can accept user information, and an output device that conveys information associated with the operation of the server system 102, or the user device itself, including digital data, visual information, or a GUI 124A, 124B, respectively. The GUI 124A, 124B each interface with at least a portion of the system 100 for any suitable purpose, including generating a visual representation of the application 126 or the administrative application 133, respectively. In particular, the GUIs 124A, 124B may each be used to view and navigate various Web pages. The GUIs 124A, 124B each provide the user with an efficient and user-friendly presentation of business data provided by or communicated within the system. The GUIs 124A, 124B may each include a plurality of customizable frames or views having interactive fields, pull-down lists, and buttons operated by the user. The GUIs 124A, 124B each contemplate any suitable graphical user interface, such as a combination of a generic web browser, intelligent engine, and command line interface (CLI) that processes information and efficiently presents the results to the user visually.

In some implementations, the network 108 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, 112C included in the end-user device 104 or the API provider system 106 can be a central processing unit (CPU), an application specific integrated circuit (ASIC), a field-programmable gate array (FPGA), or another suitable component. Each processor 112A, 112B, 112C included in the end-user device 104 or the API provider system 106 executes instructions and manipulates data to perform the operations of the end-user device 104 or the API provider system 106, respectively. Specifically, each processor 112A, 112B, 112C included in the end-user device 104 or the API provider system 106 executes the functionality required to send requests to the server system 102 and to receive and process responses from the server system 102. Each processor 112A, 112B, 112C can be a CPU, a blade, an ASIC, a FPGA, or another suitable component. Each processor 112A, 112B, 112C executes instructions and manipulates data to perform the operations of the respective system (the server system 102, the end-user device 104, and the API provider system 106). Specifically, each processor 112A, 112B, 112C executes the functionality required to receive and respond to requests from the respective system (the server system 102, the end-user device 104, and the API provider system 106), for example.

Interfaces 116A, 116B, 116C are used by the server system 102, the end-user device 104, and the API provider system 106, respectively, for communicating with other systems in a distributed environment—including within the system 100—connected to the network 108. Generally, the interfaces 116A, 116B, 116C each include logic encoded in software and/or hardware in a suitable combination and operable to communicate with the network 108. More specifically, the interfaces 116A, 116B, 116C may each include software supporting one or more communication protocols associated with communications such that the network 108 or interface's hardware is operable to communicate physical signals within and outside of the illustrated system 100.

The memory 114A, 114B, 114C may include any type of memory or database module and may take the form of volatile and/or non-volatile memory including, without limitation, magnetic media, optical media, random access memory (RAM), read-only memory (ROM), removable media, or any other suitable local or remote memory component. The memory 114A, 114B, 114C may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, the end-user device 104, or the API provider system 106, respectively.

There can be any number of end-user devices 104 and API provider systems 110 associated with, or external to, the system 100. Additionally, the example system 100 can include one or more additional user devices external to the illustrated portion of system 100 that are capable of interacting with the system 100 via the network(s) 108. Further, the term “client,” “user device,” and “user” can be used interchangeably as appropriate without departing from the scope of the disclosure. Moreover, while user device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single end-user device 104, a single API provider system 106, the system 100 can be implemented using a single, stand-alone computing device, two or more servers 102, or multiple user devices. The server system 102, the end-user device 104 and the API provider system 106 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 and the API provider system 106 can be adapted to execute any operating system or runtime environment, including Linux, UNIX, Windows, Mac OS®, Java™, Android™, iOS, Berkeley Software Distribution (BSD) or any other suitable operating system. According to one implementation, the server system 102 may also include or be communicably coupled with an e-mail server, a Web server, a caching server, a streaming data server, and/or another suitable server.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, Advanced Business Application Programming (ABAP), ABAP Object Oriented (OO), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate.

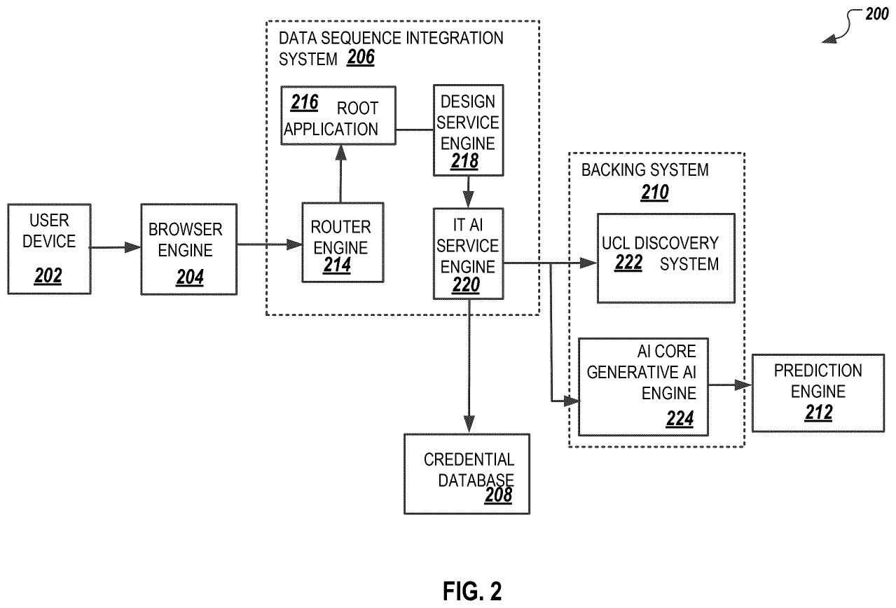

In some implementations, the API provider systems 110 can expose multiple relevant APIs in advance, with each of the APIs having a different language and a different communication protocol. The end user device 104 can include various API consumption tools, for example, API management tools, visual studio (VS) and IOS (operating system) software development kits (SDKs), build tools, and web integrated development environment (WebIDE) tools. The communication between the end user device 104 (as API consumers) and the API provider systems 110 can include several different communication protocols configured to optimize generation of data sequence integration scenario, as further described in detail with reference to FIGS. 2-5.

FIG. 2 is a block diagram of an example system architecture 200 for generation of data sequence integration, according to some implementations of the present disclosure. The example system architecture 200 includes a user device 202 (e.g., user device 104 described with reference to FIG. 1), an application engine 204 (e.g., executing application 126 described with reference to FIG. 1), a data sequence integration system 206 (e.g., data sequence integration system 110 described with reference to FIG. 1), a credential database 208 (e.g., memory 114A described with reference to FIG. 1), a backing system 210 (e.g., Gen AI engine 118C described with reference to FIG. 1), and a prediction engine 212 (e.g., prediction engine 118D described with reference to FIG. 1). The data sequence integration system 206 includes a router engine 214, a root application 216, a design service engine 218, and an information technology (IT) AI service engine 220. The backing system 210 includes a unified customer landscape (UCL) discovery API 222 and an AI core Gen AI engine 224.

The data sequence integration system 206 receives requests from the user device 202, calling the application (e.g., a browser application) engine 204. The data sequence integration system 206 can include a unified AI metering framework that validates requests to verify inclusion of requirements as part of the request headers. The validated requirements can be included in a JSON Web Token (JWT).

The data sequence integration system 206 accesses the credential database 208 to verify that the credentials of the user associated with the user device 202 indicate permission to access requested systems called for the data sequence integration scenario.

The data sequence integration system 206 communicates with the backing system 210 to access backing services, including an IT-AI-service, provided by the AI core Gen AI engine 224. The AI core Gen AI engine 224 can be configured to execute data processing using PYTHON, such that the services provided by the backing system 210 can be accessed as PYTHON packages. The AI core Gen AI engine 224 can be designed to handle the execution and operations of AI assets in a standardized, scalable, and hyperscaler-agnostic way. The AI core Gen AI engine 224 facilitates testing and utilization of natural language prompts with a variety of generative AI models.

The prediction engine 212 can include LLMs (e.g., deep learning models) trained on vast quantities of unlabeled data. The training of the prediction engine 212 can include adjustment of weights to learn data sequence integration scenario, e.g., based on system (API) relationships dependencies compatibilities and application fields. The LLMs include a form of Gen AI having an ability to process text and additional input data (e.g., context data). The LLMs can include GPT 35 TURBO, GPT 35 TURBO-16K, GPT-4, or GPT-4-32K. The LLMs can be utilized in the creation of an integration data scenario, being configured to learn intricate design patterns and to possess semantic understanding for tasks related to natural language processing. The features of Gen AI can be accessed by the AI core Gen AI engine 224, which facilitates the integration of LLMs into data sequence integration processes. The prediction engine 212 (e.g., LLM) can be stateless such that no data or sessions are stored unless a storage in memory feature is enabled. For example, UCL data, received from the UCL discovery system 222, can be retrieved and processed as transient objects. UCL requests require user context which can be formed from the JWT, received from the information technology (IT) AI service engine 220 of the data sequence integration system 206.

The example system architecture 200 includes an innovative data sequence integration generation system that employs a robust digital assistant to identify diverse systems (e.g., APIs) using the UCL discovery system 222. The example system architecture 200 provides an efficient question answering engine for reducing the search space, to reduce the search from the data provided by the UCL discovery system 222 to a relevant portion of the systems based on the context associated with an intent of the received request. The data sequence integration system architecture 206 feeds the relevant portion of the data (as embeddings) to the LLM to compose a seamless data sequence integration scenario. The LLMs can be selected to minimize response times (e.g., exclude service level agreements). The LLMs can be selected to maximize service output by avoiding LLMs with data processing (e.g., service rate) limit. The LLMs can be selected to increase data security through content filters.

The example system architecture 200 can be further optimized by efficient training of the adjusted weights of the prediction engine. Large language models can have billions or trillions of weights to update each training iteration. By relying on finetuning the weights of a pretrained base language processing network to generate the data sequence integration scenario, the system can drastically reduce the computational resources required to train the adjusted weights. In particular, the system can use a low-rank approximation, or prompt tuning, to generate the adjusted weights for the prediction engines. The example system architecture 200 provides data sequence integration scenario for streamlined execution of services and data generation. The example system architecture 200 ensures comprehensive coverage, adaptability, and efficiency in data sequence utilization. The example system architecture 200 manages multiple (e.g., all) stages of AI lifecycle using services applicable to different AI scenarios. The AI core Gen AI engine 224 of the example system architecture 200 supports multitenancy facilitating work with tenant aware applications. The example system architecture 200 facilitates consumption of an LLM (e.g., GPT-4) in the AI core Gen AI engine 224. The example system architecture 200 includes deployment of LLM by making REST calls to the AI core Gen AI engine 224, first to create a configuration with the model details and then deploy the stored configuration. The deployment URL fetched in the response is available across a particular resource group of the example system architecture 200 and can be reused. A resource group is a unique dedicated namespace or workspace environment where users can create or add configurations, deployments, artifacts etc. For every tenant of the AI core Gen AI engine 224, a default resource group can be automatically created. A resource group can use the same trained prediction engine for the creation of data sequence integration.

FIG. 3 is a block diagram of an example data sequence integration generation scenario 300, according to some implementations of the present disclosure. The example data sequence integration generation scenario 300 can be executed by a user device 302 (e.g., user device 104 described with reference to FIG. 1 and/or user device 202 described with reference to FIG. 2), a data sequence integration system 304 (e.g., data sequence integration system 110 described with reference to FIG. 1 and/or data sequence integration system 206 described with reference to FIG. 2), and a prediction engine 306 (e.g., prediction engine 118D described with reference to FIG. 1 and/or prediction engine 212 described with reference to FIG. 2). The prediction engine 306 can include multiple Gen AI tools. For example, the prediction engine 306 can include a first prediction engine (e.g., first Gen AI tool) configured for systems and APIs discovery and a second prediction engine (e.g., second Gen AI tool) configured for sequence generation.

At 308, the example data sequence integration generation scenario 300 can be initiated by the user device 302 receiving a request (e.g., a query) as natural language text to execute one or more operations using one or more systems. At 310, the user device 302 processes the request to determine requirements included in the request. At 312, the user device 302 transmit the requirements to the data sequence integration system 304.

At 314, the data sequence integration system 304 processes the requirements for determining an intent of the request formatted as JWT. At 316, the data sequence integration system 304 uses an AI service engine (e.g., IT AI service engine 220 described with reference to FIG. 2) to perform intent validation and context initialization. At 318, a request for requirement update is transmitted to the user device. Updated requirements are processed and validated. At 320, validated requirements and context are used, by the data sequence integration system 304, to generate a prompt that is transmitted, by the data sequence integration system 304, to the prediction engine 306.

At 322, the prompt is executed with requirements, by the prediction engine 306, to generate a response including the intent or modified requirements and questions. At 324, the response is formatted as a JSON schema. At 326, the JSON schema is used, by the prediction engine 306, to retrieve data characterizing (internal and external) systems and APIs from UCL (e.g., UCL discovery system 222 described with reference to FIG. 2). In some implementations, a PYTHON package is used for system and API discovery and authentication. The PYTHON package uses external libraries (e.g., collections of pre-written functions) for discovery and authentication. The PYTHON package gets certificates, provides a prompt for the prediction engine 306 to determine available systems and APIs applicable to the request, ranks (e.g., using fuzzy ranking) the determined available systems and APIs, and selects a set number of top-ranked systems and APIs. The prediction engine 306 can use an authorization token (AI Gen credentials) to retrieve and process data regarding accessible systems and APIs to determine available systems and APIs applicable to the request. At 328, the data characterizing (internal and external) systems and APIs is processed to rank matching systems and API's could generate a data sequence based on a defined order of calling selected systems and APIs. At 330, the defined order of calling selected systems and APIs and the intent are formatted for transmission to the user device 302. At 332, the defined order of calling selected systems and APIs are transmitted, by the data sequence integration system 304 to the user device 302, for display on a graphical user interface (e.g., GUI 124A described with reference to FIG. 1).

At 334, the intent and the order of selected systems are displayed by the graphical user interface of the user device. At 336, a user response regarding the intent and the order is received. The user response includes an approval of the displayed intent and of the order of selected systems and APIs or includes a request to modify any portion of the order of selected systems and APIs.

At 338, the user response is transmitted, by the user device 302 to the data sequence integration system 304, to generate an enriched intent including the user selection. The enriched intent can be generated using a prediction engine (e.g., GPT4) and UCL populating values of the source and target system details with a prediction of data scenario type. An example for complete intent JSON generated post LLM and UCL enrichment is provided as:

```
  {
  “name”: “Document Replication”,
  “description”: “Replicate documents from abhe-mysystem-system cloud to abhe-
  mysystem -cloud Plant Maintenance once a day at 8:00 AM”, “integrationType”:
“replicate”,
  “eventType” : “quartz”, “eventConfiguration”: “0 0 8 * * ?”, “sourceSystem”: {
  “description”: “The source system from where documents will be fetched”,
“name”: “mysystem-- system -cloud”,
  “type”: “ system Cloud”, “object”: “Document”,
  “action”: “Read”, “ucl”: {
  “id”: 60,
  “text”: {
  “systemDescription”: “abhe-mysystem-- system -cloud”, “systemTitle”
  “entryPoints”: [
  {
  “value”: “https://my300098- api. system.ondemand.com: /API_server”
  }
  ],
  “description”: “\r\n\r\nThe service is based on the *OData* protocol, and can be
consumed by external systems and user interfaces to integrate with incoming VAT document
management in system Cloud. Create a complete record including document header, item and
binding record in one single call. Perform the following operations: declare, receive, and sign off
the document.\r\n”,
  “title”: “Incoming VAT Document”,
  “ordId”: “ system:apiResource:API_model:v1”, “resourceDefinitions”: [
  {
  “customType”: ““,
  “mediaType”: “application/xml”, “type”: “edmx”,
  “url”: “http:// discovery.api /open-resource- discovery-static/v0”
  },
  {
  “customType”: ““,
  “mediaType”: “application/json”, “type”: “openapi-v3”,
  “url”: “http://canary.discovery.api /open-resource- discovery /v0/api “
  }
  ],
  “visibility”: “public”,
  “shortDescription”: “Create, update and read incoming data for target location
using this synchronous inbound service”,
  “apiProtocol”: “odata-v2”, “version”: “1.0.0”,
  “id”
  }
  }
  },
  “targetSystem”: {“description”: “The target system where documents will be
replicated to”, “name”: “abhe-mysystem-- system -cloud Plant Maintenance”,
  “type”: “ system Cloud”, “object”: “Document”,
  “action”: “Create”, “ucl”: {
  “id”: 60,
  “text”: {
  “systemDescription”: “abhe-mysystem-- system -cloud”, “systemTitle”: “abhe-
mysystem-- system -cloud”, “systemBaseUrl”: “https://mysystem.ondemand.com”,
“systemNamespace”: “ system “,
  “entryPoints”: [
  {
  “value”: “https://myapi.system”
  }
  ],
  “description”: “\r\n\r\nThe service is based on the *OData* protocol, and can be
consumed by external systems and user interfaces to integrate with incoming data management in
system Cloud. Create a complete record including document header, item and binding record in
one single call. Perform the following operations: declare, receive, and sign off the document.\r\n”,
  “title”: “Incoming VAT Document”,
  “ordId”: “ system “: [
  {
  “customType”: ““,
  “mediaType”: “application/xml”
  “type”: “edmx”,
  “url”: “http://canary.discovery.api.system/open-resource”
  },
  {
  “customType”: ““,
  “mediaType”: “application/json”, “type”: “openapi-v3”,
  “url”: “http:// discovery.api /open-resource- discovery-static/v0/api “
  }
  ],
  “visibility”: “public”,
  “shortDescription”: “Create, update and read incoming data for target location
using synchronous inbound service”,
  “apiProtocol”: “odata-v2”, “version”: “1.0.0”,
  “id”: “fw5tag-a21c-f54yhsr-f2r6tyegf”
  }}}}.
```

At 340, the data sequence integration scenario is generated, by the data sequence integration system 304 using a migration framework including predefined templates indicating which components can be added. At 342, data migration is invoked. At 344, the content of the data sequence integration scenario is stored into data packages into a memory (e.g., memory 114A described with reference to FIG. 1).

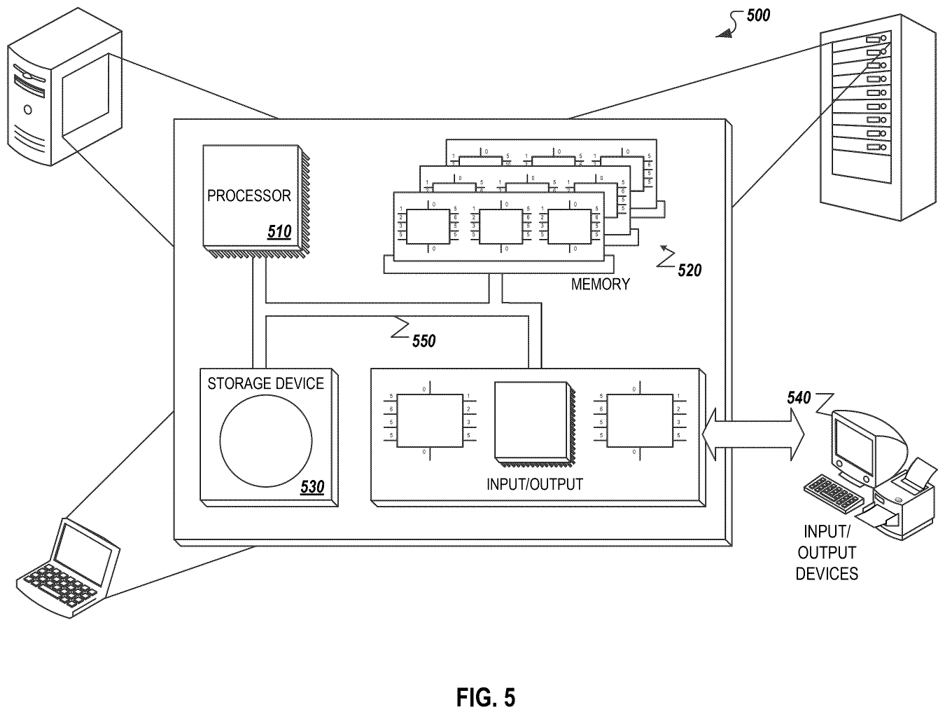

FIG. 4 is a flowchart of an example process 400 for generation of data sequence integration scenario, according to some implementations of the present disclosure. The example process 400 can be performed by any component of the example system 100, described with reference to FIG. 1 or the example system architecture 200, described with reference to FIG. 2 or the example computing system 500, described with reference to FIG. 5. For clarity of presentation, the description that follows generally describes example process 400 in the context of FIGS. 1, 2, and 5.

At 402, a request to generate a data sequence integration scenario is received by a processor of a user device or by a processor of a server from a user device. The request can be formatted using natural language and can include one or more textual requirements. The textual requirements of the request can define one or more systems (e.g., source and target systems) and an action to be performed relative to the identified systems. For example, the request can be a sentence such as “I would like to replicate newly hired employee data from First System Name to Second System Name to run an onboarding process.” In some implementations, LLMs are used to annotate and identify the textual requirements included in the request. The LLMs can generate structured a form of textual requirements.

At 404, the request is validated, by the processor, by processing the one or more textual requirements. Validation of the request by processing the one or more textual requirements includes a verification of use cases and supported features of an enterprise system. The verification can be executed according to one or more conditions defining a minimum number of textual requirements to be included to enable processing of the request, such as inclusion in the request of at least one source system, at least one target system, at least one action, and/or at least one data type. In some implementations, in response to determining that the request is missing at least one textual requirement, a response is displayed by a graphical user interface of the user device requesting the missing textual requirement. The request for the missing textual requirement can include an example of an acceptable type of textual requirement.

At 406, an intent is determined from the one or more textual requirements. The intent can be formatted as JSON schema (e.g., JWT) using a simple dot notation or, for more functionality, using SQL/JSON functions and conditions. The intent can be created from the textual requirements, as a data guide that summarizes the structure and type information corresponding to the textual requirements. In some implementations, UCL or system discovery are accessed, using a PYTHON build package, to identify, by a first prediction engine, for each system and/or API included in the textual requirements, a particular system or instance or API for integration. For example, the first prediction engine can include a generative AI authorized to access system and API data to discover systems and APIs potentially matching the request. The first prediction engine can be trained to identify systems and APIs based on a data object and an action.

At 408, information is automatically retrieved by processing the intent. For example, the information including for each of the source system and target system a description, a name, a type, an object, and/or an action is generated. The information can include a use case and a context of the request. The use case can include a feature identifier registered through a ticket associated with the request. The context can be formed from the JWT to define a value or an identifier of the data objects to be included in the data sequence integration scenario. The identifier can uniquely identify the data object, for which particular occurrences are counted to be included in the data sequence integration scenario. The information can also include a tenant identifier and/or a product type. The tenant identifier can include an identifier of a user of the user device initiating the request or an identifier of an entity, for whom the data sequence integration scenario is being generated. The product type can include an identifier of a product that can be included in a data object package. In some implementations, additional information (e.g., information related to external systems) is retrieved from a backing system including UCL discovery API and AI core generative AI engine. In some implementations, the information is filtered. For example, a plurality of systems identified as potentially matching the textual requirements can be ranked (e.g., using a fuzzy ranking technique) to select systems to be used for the data sequence integration scenario. The information is converted to a prompt processable by a second prediction engine.

At 410, the intent and the context of the request are provided as a prompt to the second prediction engine to generate the data sequence integration scenario responsive to the prompt. The second prediction engine can include a trained LLM. The trained LLM is trained using a plurality of requests mapped to API sequence settings. The API sequence settings define workflow conditions for a plurality of API types. The plurality of API types can be determined and ranked to generate a ranked API list. A user input can include a selection of API types from the ranked API list. The selection can be used to generate an enriched intent including the selection of API types. APIs ranking of relevant APIs can be determined by using a similarity function between the vector representations and the request. The similarity function can include a cosine similarity function.

At 412, the data sequence integration scenario is generated by the second prediction engine. The data sequence integration scenario can be generated using an API call to generate data integration scenario according to an optimized sequence of data transmission between the systems to perform actions involving identified APIs. The data integration scenario can be defined by templates indicating which components can be added. The templates can correspond to particular scenarios. For example, a “GEN_AI_BASELINE_TIMER” template can be used for a scenario including a default case having a scenario pattern, such as “timer start defaulted to every 5 minutes, request-reply and end message,” that includes a description defining the template use for scheduled or replication-based integrations. As another example, “GEN_AI_BASELINE_SENDER” template can be used for a scenario including a scenario pattern, such as “start message, request-reply and end message,” that includes a description defining the template use for HTTPS and SOAP-Sender-based integration.

At 414, a graphical representation of the data sequence integration scenario is provided for display to the user device. In some implementations, the graphical representation of the data sequence integration scenario is displayed in a UI of a digital assistant. In some examples, the graphical representation can be provided as a web-based rendering using a web rendering runtime that is built into the popover container (e.g., iframe). In some examples, the graphical representation is compatible with a UI framework of the popover container.

At 416, a user input can be received, from the user device, in response to the display of the data sequence integration scenario. In some implementations, a user input can include an approval of the data sequence integration scenario. In response to the data sequence integration scenario being approved, the content of the data sequence integration scenario is stored into data packages into a memory (e.g., memory 114A described with reference to FIG. 1).

At 418, an application invoking the sequence of APIs selected according to the calling order of the data sequence integration scenario is executed. The execution of the application can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data integration scenario. The output of the automatically embed API calls in source code can be displayed by a graphical user interface.

The example process 400 for generation of data sequence integration scenario provides an advantage of contextualizing the LLM with the intent and a context of the request during finetuning or inference, which enhances the accuracy of the identification of relevant system and/or API calling patterns, facilitating optimized generation of data sequence integration scenario. The described example process 400 integrates a deeper understanding of users' historical patterns and latent intent, enabling LLMs to tailor responses and generate optimized API sequences based on training. The example process 400 employs sophisticated fusion techniques and conducts a comprehensive empirical evaluation across multiple internal and external system types and/or API types and versions to provide a thorough assessment of system and API relevance and compatibility for the requested data sequence integration scenario.

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500, such as the example processes 300 and 400 described with reference to FIGS. 3 and 4. Such executed instructions can implement one or more components of, for example, the data sequence integration system 110, described with reference to FIG. 1. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAS computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving a request to generate a data sequence integration scenario, the request comprising one or more textual requirements; validating the request by processing the one or more textual requirements to determine inclusion of a minimal number of systems and actions; determining, using a first prediction engine, an intent and a context of the request from the one or more textual requirements, the intent comprising top-ranked systems and APIs matching the request; inputting the intent and the context of the request as a prompt to a second prediction engine; and receiving, from the second prediction engine, the data sequence integration scenario, responsive to the prompt, the data sequence integration scenario defining an order of the actions to be performed by the top-ranked systems and APIs matching the request.

Example 2. The computer-implemented method of the preceding example, wherein the first prediction engine and the second prediction engine comprise a trained large language model.

Example 3. The computer-implemented method of any of the preceding examples, wherein the trained large language model is trained using a plurality of requests mapped to system and API sequence settings.

Example 4. The computer-implemented method of any of the preceding examples, wherein the system and API sequence settings define workflow conditions for a plurality of system types and API types.

Example 5. The computer-implemented method of any of the preceding examples, further comprising: determining, using the first prediction engine, the plurality of system types and API types; ranking the plurality of system types and API types as a ranked system and API list; receiving a selection of system types and API types from the ranked system and API list; and generating an enriched intent comprising the selection of system types and API types.

Example 6. The computer-implemented method of any of the preceding examples, further comprising: invoking a migration by retrieving one or more systems and APIs in a sequence of systems and APIs from a database, the migration calling predefined templates.

Example 7. The computer-implemented method of any of the preceding examples, further comprising: generating a graphical representation of the sequence of systems and APIs as the data sequence integration scenario.

Example 8. The computer-implemented method of any of the preceding examples, wherein validating the request by processing the one or more textual requirements comprises a verification of use cases and supported features of an enterprise system.

Example 9. The computer-implemented method of any of the preceding examples, wherein determining, using the first prediction engine, the intent of the request comprises accessing external libraries and providing an authorization token to the first prediction engine to access system data and API data to discover available systems and available APIs matching the request.

Example 10. A system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving a request to generate a data sequence integration scenario, the request comprising one or more textual requirements; validating the request by processing the one or more textual requirements to determine inclusion of a minimal number of systems and actions; determining, using a first prediction engine, an intent and a context of the request from the one or more textual requirements, the intent comprising top-ranked systems and APIs matching the request; inputting the intent and the context of the request as a prompt to a second prediction engine; and receiving, from the second prediction engine, the data sequence integration scenario, responsive to the prompt, the data sequence integration scenario defining an order of the actions to be performed by the top-ranked systems and APIs matching the request.

Example 11. The system of the preceding example, wherein the first prediction engine and the second prediction engine comprise a trained large language model.

Example 12. The system of any of the preceding examples 1, wherein the trained large language model is trained using a plurality of requests mapped to system and API sequence settings.

Example 13. The system of any of the preceding examples, wherein the system and API sequence settings define workflow conditions for a plurality of system types and API types.

Example 14. The system of any of the preceding examples, further comprising: determining, using the first prediction engine, the plurality of system types and API types; ranking the plurality of system types and API types as a ranked system and API list; receiving a selection of system types and API types from the ranked system and API list; and generating an enriched intent comprising the selection of system types and API types.

Example 15. The system of any of the preceding examples, further comprising: invoking a migration by retrieving one or more systems and APIs in a sequence of systems and APIs from a database, the migration calling predefined templates.

Example 16. The system of any of the preceding examples, further comprising: generating a graphical representation of the sequence of systems and APIs as the data sequence integration scenario.

Example 17. The system of any of the preceding examples, wherein validating the request by processing the one or more textual requirements comprises a verification of use cases and supported features of an enterprise system.

Example 18. The system of any of the preceding examples, wherein determining, using the first prediction engine, the intent of the request comprises accessing external libraries and providing an authorization token to the first prediction engine to access system data and API data to discover available systems and available APIs matching the request.

Example 19. A non-transitory computer-readable media encoded with a computer program, the computer program comprising instructions that when executed by one or more computers cause the one or more computers to perform operations comprising: receiving a request to generate a data sequence integration scenario, the request comprising one or more textual requirements; validating the request by processing the one or more textual requirements to determine inclusion of a minimal number of systems and actions; determining, using a first prediction engine, an intent and a context of the request from the one or more textual requirements, the intent comprising top-ranked systems and APIs matching the request; inputting the intent and the context of the request as a prompt to a second prediction engine; and receiving, from the second prediction engine, the data sequence integration scenario, responsive to the prompt, the data sequence integration scenario defining an order of the actions to be performed by the top-ranked systems and APIs matching the request.

Example 20. The non-transitory computer-readable media of any of the preceding examples, wherein the first prediction engine and the second prediction engine comprise a trained large language model and wherein the trained large language model is trained using a plurality of requests mapped to system and API sequence settings.

What is claimed is:

1. A computer-implemented method comprising:
receiving a request to generate a data sequence integration scenario, the request comprising one or more textual requirements;
validating the request by processing the one or more textual requirements to determine inclusion of a minimal number of systems and actions;
determining, using a first prediction engine, an intent and a context of the request from the one or more textual requirements, the intent comprising top-ranked systems and APIs matching the request;
inputting the intent and the context of the request as a prompt to a second prediction engine; and
receiving, from the second prediction engine, the data sequence integration scenario, responsive to the prompt, the data sequence integration scenario defining an order of the actions to be performed by the top-ranked systems and APIs matching the request.

2. The computer-implemented method of claim 1, wherein the first prediction engine and the second prediction engine comprise a trained large language model.

3. The computer-implemented method of claim 2, wherein the trained large language model is trained using a plurality of requests mapped to system and API sequence settings.

4. The computer-implemented method of claim 3, wherein the system and API sequence settings define workflow conditions for a plurality of system types and API types.

5. The computer-implemented method of claim 4, further comprising:
determining, using the first prediction engine, the plurality of system types and API types;
ranking the plurality of system types and API types as a ranked system and API list;
receiving a selection of system types and API types from the ranked system and API list; and
generating an enriched intent comprising the selection of system types and API types.

6. The computer-implemented method of claim 1, further comprising:
invoking a migration by retrieving one or more systems and APIs in a sequence of systems and APIs from a database, the migration calling predefined templates.

7. The computer-implemented method of claim 6, further comprising:
generating a graphical representation of the sequence of systems and APIs as the data sequence integration scenario.

8. The computer-implemented method of claim 1, wherein validating the request by processing the one or more textual requirements comprises a verification of use cases and supported features of an enterprise system.

9. The computer-implemented method of claim 1, wherein determining, using the first prediction engine, the intent of the request comprises accessing external libraries and providing an authorization token to the first prediction engine to access system data and API data to discover available systems and available APIs matching the request.

10. A system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving a request to generate a data sequence integration scenario, the request comprising one or more textual requirements;
validating the request by processing the one or more textual requirements to determine inclusion of a minimal number of systems and actions;
determining, using a first prediction engine, an intent and a context of the request from the one or more textual requirements, the intent comprising top-ranked systems and APIs matching the request;
inputting the intent and the context of the request as a prompt to a second prediction engine; and
receiving, from the second prediction engine, the data sequence integration scenario, responsive to the prompt, the data sequence integration scenario defining an order of the actions to be performed by the top-ranked systems and APIs matching the request.

11. The system of claim 10, wherein the first prediction engine and the second prediction engine comprise a trained large language model.

12. The system of claim 11, wherein the trained large language model is trained using a plurality of requests mapped to system and API sequence settings.

13. The system of claim 12, wherein the system and API sequence settings define workflow conditions for a plurality of system types and API types.

14. The system of claim 13, further comprising:
determining, using the first prediction engine, the plurality of system types and API types;
ranking the plurality of system types and API types as a ranked system and API list;
receiving a selection of system types and API types from the ranked system and API list; and
generating an enriched intent comprising the selection of system types and API types.

15. The system of claim 10, further comprising:
invoking a migration by retrieving one or more systems and APIs in a sequence of systems and APIs from a database, the migration calling predefined templates.

16. The system of claim 15, further comprising:
generating a graphical representation of the sequence of systems and APIs as the data sequence integration scenario.

17. The system of claim 10, wherein validating the request by processing the one or more textual requirements comprises a verification of use cases and supported features of an enterprise system.

18. The system of claim 10, wherein determining, using the first prediction engine, the intent of the request comprises accessing external libraries and providing an authorization token to the first prediction engine to access system data and API data to discover available systems and available APIs matching the request.

19. A non-transitory computer-readable media encoded with a computer program, the computer program comprising instructions that when executed by one or more computers cause the one or more computers to perform operations comprising:
receiving a request to generate a data sequence integration scenario, the request comprising one or more textual requirements;
validating the request by processing the one or more textual requirements to determine inclusion of a minimal number of systems and actions;
determining, using a first prediction engine, an intent and a context of the request from the one or more textual requirements, the intent comprising top-ranked systems and APIs matching the request;
inputting the intent and the context of the request as a prompt to a second prediction engine; and
receiving, from the second prediction engine, the data sequence integration scenario, responsive to the prompt, the data sequence integration scenario defining an order of the actions to be performed by the top-ranked systems and APIs matching the request.

20. The non-transitory computer-readable media of claim 19, wherein the first prediction engine and the second prediction engine comprise a trained large language model and wherein the trained large language model is trained using a plurality of requests mapped to system and API sequence settings.
